(19) United States
(12) Patent Application Publication
(10) Pub. No.: US 2014/0317181 A1
(43) Pub. Date: Oct. 23, 2014

(54) ESTABLISHING DYNAMIC CONNECTION

(71) Applicant: Hangzhou H3C Technologies Co., Ltd., Hangzhou, Zheijiang (CN)

(72) Inventors: Pengcheng Lin, Beijing (CN); Di Zhou, Beijing (CN)

(21) Appl. No.: 14/355,140

(22) PCT Filed: Dec. 19, 2012
(86) PCT No.: PCT/CN2012/086908

§ 371 Date: Apr. 29, 2014

(30) Foreign Application Priority Data
Dec. 31, 2011 (CN) 201110458162.6

(51) Int. Cl. H04L 29/08; H04L 29/06

(52) U.S. Cl. CPC H04L 67/141; H04L 67/42
USPC 709/203

(57) ABSTRACT

The disclosure relates to a method establishing dynamic connection. Said method comprises receiving, by a management server, a connection establishment request message sent by a client, wherein said request message carries a first property information of a service source terminal to which connection is requested to be established; sending, by the management server, a connection instruction message carrying identification information of the client and said first property information to the service source terminal, so that the service source terminal determines whether to establish a connection to the client according to the first property information.

### BACKGROUND

With the development of network technologies, various applications and services, such as video on demand and storage backup, are extensively applied to networks. Analog or digital data of all these services is converted into IP messages through a service source sending terminal, and then said IP messages are forwarded through networks to clients requesting the services. In order to effectively manage these services, a core management server would be present in the application system.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a schematic architecture drawing of an application system network according to an example;

FIG. 2 is a flow chart of a method for establishing service connection according to an example;

FIG. 3 is a flow chart of a method for establishing dynamic connection according to an example;

FIG. 4 is a signaling diagram of a method for establishing dynamic connection according to an example;

FIG. 5 is a structural diagram of a management server according to an example; FIG. 6 is a structural diagram of a service source sending terminal according to an example.

### DETAILED DESCRIPTION

As used herein, the term “includes” means includes but not limited to, the term “including” means including but not limited to. The term “based on” means based at least in part on. In addition, the terms “a” and “an” are intended to denote at least one of a particular element.

In the following, certain examples are described in detail with reference to the drawings.

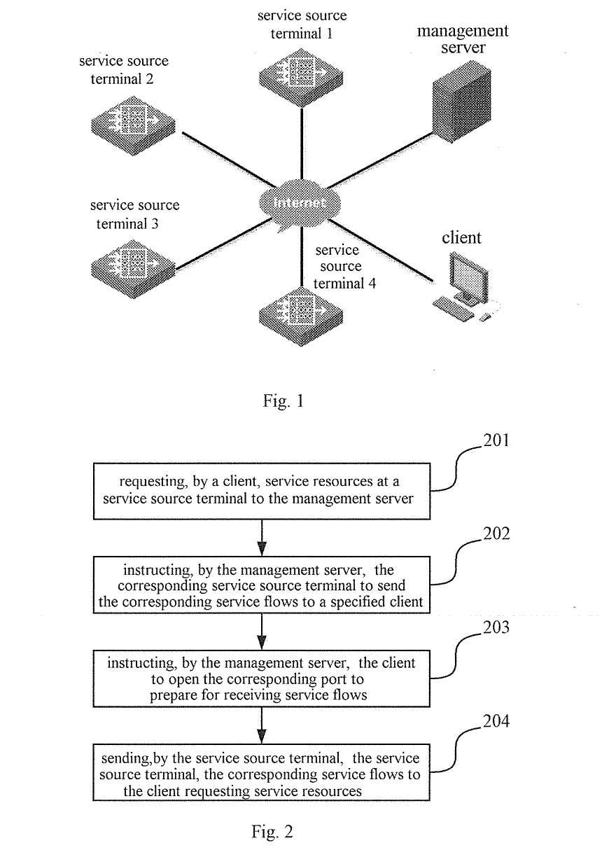

With the reference to FIG. 1, FIG. 1 is a schematic architecture drawing of an application system network according to an example, wherein said application system network comprises a management server, a service source sending terminal (hereinafter referred to as “service source terminal”), a client requesting service (hereinafter referred to as “client”) and a corresponding software management system. The client requests to the management server to establish a service relationship with the service source terminal, the management server informs the service source terminal to send service flows to the client, and the client performs application forwarding after receiving service flows to realize real time application.

With the reference to FIG. 2, FIG. 2 is a flow chart of a method for establishing service connection according to an example.

At block 201, said method comprises requesting, by a client, service resources at a service source terminal to the management server.

At block 202, said method comprises instructing, by the management server, the corresponding service source terminal to send the corresponding service flows to a specified client.

At block 203, said method comprises instructing, by the management server, the client to open the corresponding port to prepare for receiving service flows.

At block 204, said method comprises sending, by the service source terminal, the corresponding service flows to the client requesting service resources.

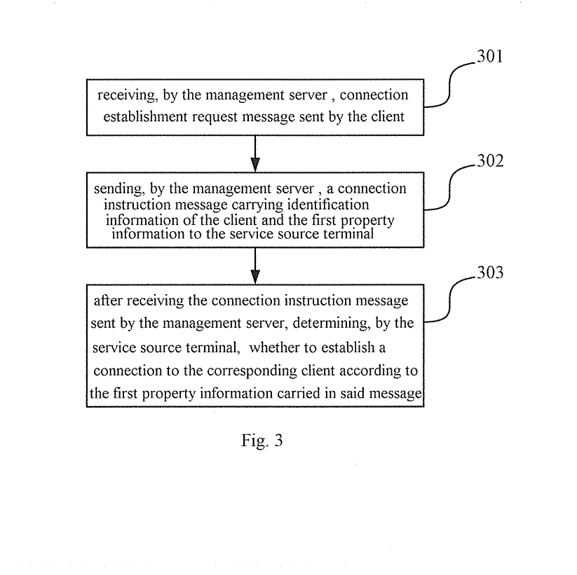

With the reference to FIG. 3, FIG. 3 is a flow chart of a method for establishing dynamic connection according to an example.

At block 301, said method comprises receiving, by a management server, a connection establishment request message sent by a client, wherein said request message carries a first property information of a service source terminal to which connection is requested to be established.

In the example, in order to enable the client to establish dynamic connections to different service source terminals according to specific situations of the service source terminals, the connection establishment request message sent by the client may carry the first property information of the service source terminal to which connection is requested to be established so as to request to establish connection to the service source terminal that satisfies said first property information. Wherein, said first property information can be condition information of the number of a quantifiable subject (e.g. person, vehicle), can also be properties of an action (e.g. running the red light, breaking through the cordon, etc.) whose nature can be determined, and so on.

In the example, a user interface presented on the client may include an input box, so that a user can input a dynamic property demand in the input box according to his own need and initiate a connection establishment request.

For example, in a video monitoring system, said first property information may be that the number of persons in the picture monitored by the service source terminal (monitoring camera) exceeds a certain threshold (e.g. 10 persons), namely, the client requests to establish a connection to the service source terminal whose monitored picture contains more than 10 persons.

At block 302, said method comprises sending, by the management server, a connection instruction message carrying identification information of the client and the first property information to the service source terminal.

Specifically, the management server, after receiving the connection establishment request message sent by the client, can send the connection instruction message carrying identification information of the client and first property information to all service source terminals in the system, so that the service source terminals determine according to the first property information whether a connection should be established to the client.

In order to improve system security, the management server can store access authority information of each client corresponding to the identification information of the client. After receiving the connection establishment request message sent by the client, the management server determines the service source terminal to which said client has the authority to access and sends the connection instruction message to said service source terminal to which said client has the authority to access.

Further, in the example, the connection establishment request message sent by the client may also carry a second property of the service source terminal to which connection is requested to be established. Said second property can be information pre-configured in the service source terminal, such as address information (xx street of xx city) of the service source terminal, and location type information (e.g. road, indoor, square, etc.) of the service source terminal.

Correspondingly, when managing registered service source terminals, the management server may record (store) a second property information of each service source terminal corresponding to the identification information of each service source terminal. Upon receiving the connection establishment request message sent by the client, the management server inquires the corresponding service source terminal according to the second property information it has carried and the second property information of each service source terminal it has stored, and sends to the inquired service source terminal the connection instruction message.

Taking the application scenario shown in FIG. 1 as an example, wherein it is supposed that the second property of a service source terminal 1 is road, and the second property of service source terminals 2, 3 and 4 is square. When the connection establishment request received by the management server carries such property information as a square (second property information) containing more than 10 persons (first property information), the management server sends the connection instruction message to the service source terminals 2, 3 and 4, which carries the first property information (more than 10 persons) of the service source terminal to which the client requests to establish a connection.

At block 303, said method comprises upon receiving the connection instruction message sent by the management server, determining, by the service source terminal, whether a connection should be established to the corresponding client according to the first property information carried in said message.

Specifically, after receiving the connection instruction message sent by the management server, the service source terminal obtains the first property information carried therein and determines whether it satisfies said first property information, and when the result of determination is yes, a connection establishment acknowledgment message will be returned to the corresponding client to establish a connection.

In the example, the service source terminal may have three states. The service source terminal is in an initial state when it has not established a connection to the client and has not received the connection instruction message; the service source terminal is in a standby state when it has not established a connection to the client but has received the connection instruction message; the service source terminal is in a forwarding state after it has established a connection to the client.

After receiving the connection instruction message, the service source terminal enters the standby state from the initial state, and determines whether it satisfies the first property information, if yes, it enters the forwarding state and returns the connection establishment acknowledgment message to the client so as to establish connection to the client to perform real-time services; if the service source terminal determines that it does not satisfy the first property information, the service source terminal stays in the standby state and continues to determine (e.g. periodically or regularly) whether it satisfies the first property information; when the service source terminal is in the forwarding state while discovering that it does not satisfy the first property information, it returns to the standby state.

Correspondingly, in the example, the service source terminal may record connection information between its own and the client and the first property information corresponding to the client, so as to determine whether it is connected to the corresponding client according to the corresponding connection information and whether it satisfies the first property information corresponding to the client.

After receiving the connection establishment acknowledgment message returned by the service source terminal, the client establishes connection to the service source terminal and receives service flows sent from the service source terminal. Wherein, if there are a plurality of service source terminal devices that satisfy the first property of the client, the client may open a plurality of local windows to receive service flows simultaneously after receiving connection establishment acknowledgement message returned by the plurality of service source terminals, or the client may splice the plurality of service flows so as to be received in one window, or the client may return a delay request to the service source terminals one by one so as to realize sequential service switch in one window.

Further, in the example, when the client is to end the connection to the service source terminal, it may send a connection stop message to the management server; and the management server, upon receiving the connection stop message sent by the client, forwards said connection stop message to the corresponding service source terminal. Upon receiving the connection stop message, the service source terminal disconnects from the client and stops sending service flows to the client. At this time, the service source terminal will returns to the initial state no matter whether it is in the standby state or in the forwarding state. Wherein, the client may carry in the connection stop message the identification information of the service source terminal from which it is to be disconnected, so as to enable the management server to send the connection stop message to the corresponding service source terminal; or the management server may store, corresponding to the client identification, information of the service source terminal that satisfies the first property information carried in the connection establishment request sent by the client, and, upon receiving the connection stop message, sends said connection stop message to the corresponding service source terminal.

The example will be described in further detail below in conjunction with a specific application scenario. The network architecture shown in FIG. 1 is still used as an example, wherein service source terminals 1-4 are monitor cameras; the management server stores the second property information of the service source terminals 1-4: the second property information of the service source terminal 1 is road, the second property information of service source terminals 2-4 is square; the access authority of client A stored in the management server is service source terminals 1-3.

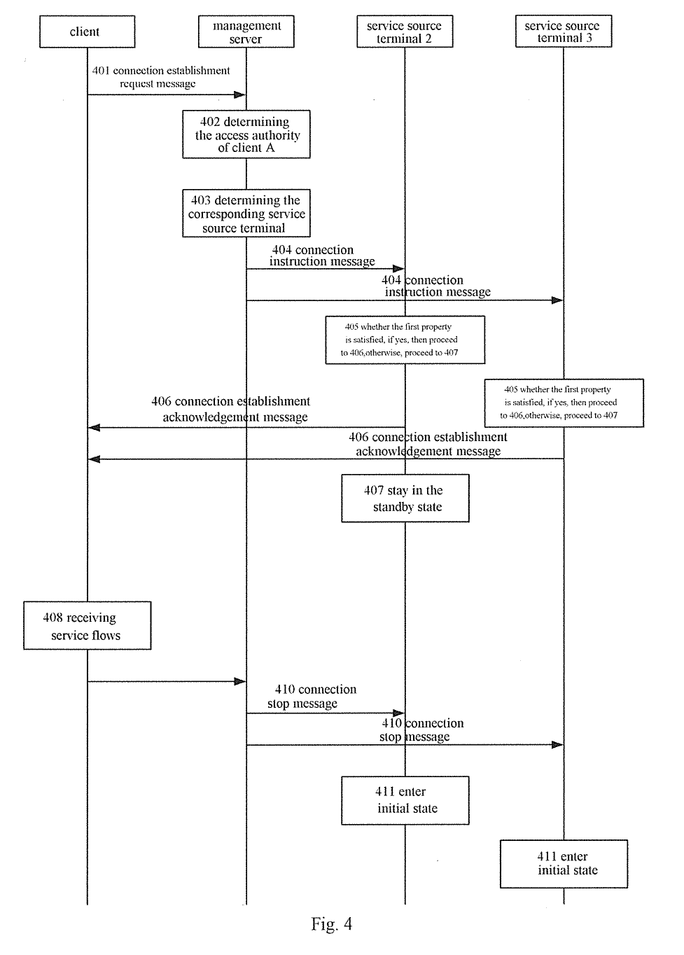

With the reference to FIG. 4, FIG. 4 is a signaling diagram of a method for establishing dynamic connection according to an example

At block 401, the client A sends a connection establishment request message to the management server, in which the property information carried in said request message is a square (second property information) containing more than 10 persons (first property information) in the monitored picture.

At block 402, the management server determines the service source terminals (i.e. service source terminals 1-3) accessible by client A according to access authority information of client A stored in the management server.

At block 403, the management server determines the corresponding service source terminals (i.e. service source terminals 2 and 3) according to the second property information carried in the received connection establishment request message and the second property information of each service source terminal it has stored.

At block 404, the management server sends the connection instruction message to service source terminals 2 and 3, which carries the first property information.

At block 405, the service source terminals 2 and 3 determine whether they satisfies the first property information, i.e. whether the number of persons in the monitored picture exceeds 10, if yes, proceeds to block 406; otherwise, proceeds to block 407.

At block 406, the service source terminals 2 and 3 return the connection establishment acknowledgment message to the client and enters the forwarding state to send service flows to the client.

At block 407, the service source terminals 2 and 3 remain in the standby state to the client.

Wherein, when the service source terminal is in the standby state or forwarding state, the service source terminal can periodically (e.g. every 2 second) determine whether it satisfies the first property information, if yes, it enters (remains in) the forwarding state; otherwise, it remains in (enters) the standby state.

At block 408, the client receives service flows send from the service source terminal after receiving the connection establishment acknowledgement message returned by the service source terminal.

Wherein, when service source terminals 2 and 3 send service flows to the client simultaneously, the client receives the service flows sent by service source terminals 2 and 3 at the some time (through two local windows).

At block 409, the client sends the connection stop message to the management server.

At block 410, the management server forwards said connection stop message to service source terminals 2 and 3.

At block 411, the service source terminals 2 and 3 enter the initial state.

It can be seen from the above descriptions that in the example, the service connection request message sent by the client carries the first property information of the service source terminal to which connection is requested to be established; the management server, upon receiving the service connection request message sent by the client, sends the connection instruction message carrying identification information of the client and first property information to the service source terminal, so that the service source terminal determines, according to said first property information, whether a connection should be established to the corresponding client, thus realizing dynamic establishment of service connection and increasing resource utilization rate.

Based on the same technical concept as that of the above method, the present disclosure also provides a management server that can be applied to said method.

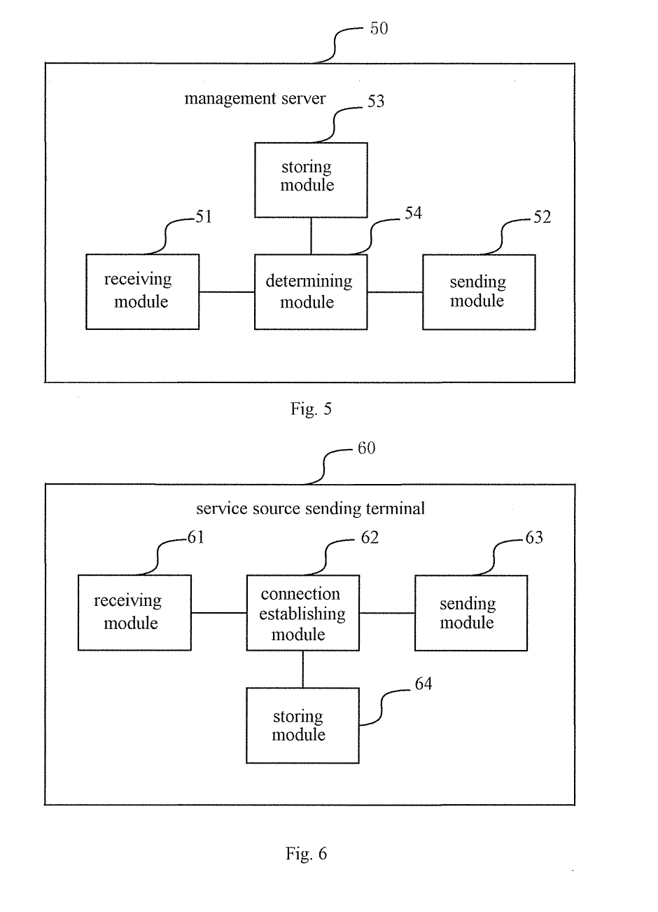

With the reference to FIG. 5, FIG. 5 is a structural diagram of a management server 50 according to an example. Said management server 50 comprises a receiving module 51, a sending module 52, a storing module 53 and a determining module 54.

The receiving module 51 is to receive a connection establishment request message sent by a client, wherein said request message carries a first property information of a service source terminal to which connection is requested to be established.

The sending module 52 is to send a connection instruction message carrying identification information of the client and said first property information to the service source terminal, so that the service source terminal determines whether to establish a connection to the client according to said first property information.

Wherein, the connection establishment request message further comprises a second property information of the service source terminal to which connection is requested to be established.

The storing module 53 is to store a second property information of each service source terminal corresponding to the identification information of each service source terminal.

The determining module 54 is to determine the corresponding service source terminal according to the second property information carried in the connection establishment request message received by the receiving module 51 and the second property information of each service source terminal stored in the storing module 53.

The sending module 52 is specifically to send, to the service source terminal determined by the determining module 54, a connection instruction message carrying the identification information of the client and said first property information.

Wherein, the service source terminal, after receiving the connection instruction message, determines whether it satisfies the first property information or not, if yes, it establishes connection to the client and sends service flows to said client; otherwise, it does not establish connection to said client.

Further, when the service source terminal has established connection to said client and determines that it does not satisfy the first property information, it stops sending service flows to the client.

When the service source terminal has not established connection to the client, and determines that it satisfies said first property information, it establishes connection to the client and sends service flows to the client.

Based on the same technical concept as that of the above method, the present disclosure also provides a service source terminal that can be applied to said method.

With the reference to FIG. 6, FIG. 6 is a structural diagram of a service source sending terminal 60 according to an example. Said service source sending terminal 60 comprises a receiving module 61, a connection establishing module 62, a sending module 63 and a storing module 64.

The receiving module 61 is to receive a connection instruction message sent by the management server, wherein said connection instruction message carries a first property information of a service source terminal to which the client requests to establish connection.

The connection establishing module 62 is to determine whether to establish connection to the client according to said first property information.

Wherein, the connection establishing module 62 is specifically to determine whether the service source terminal satisfies said first property information, if yes, establish connection to the client; otherwise, not establish connection to the client.

The sending module 63 is to send service flows to the client when the connection establishing module determines that the service source terminal satisfies said first property information.

The storing module 64 is to store connection information between said service source terminal and the client and the first property information corresponding to the client.

The connection establishing module 62 is further to establish connection to the client so as to send service flows to the client by the sending module 63 when it is determined according to the connection information stored in the storing module 64 that the service source terminal does not establish connection to the client and it is determined that the service source terminal satisfies the first property corresponding to the client.

the sending module 63 is further to stop sending service flows to the client when the connection establishing module 62 determines, according to the connection information stored in the storing module 64, that a connection has been established between the service source terminal and the client, and the connection establishing module 62 determines that the service source terminal does not satisfy the first property information corresponding to the client.

The above examples can be implemented by hardware, software or firmware or a combination thereof. For example the various methods, processes and functional units described herein may be implemented by a processor (the term processor is to be interpreted broadly to include a CPU, processing unit. ASIC, logic unit, or programmable gate array etc.). The processes, methods and functional units may all be performed by a single processor or split between several processers; reference in this disclosure or the claims to a ‘processor’ should thus be interpreted to mean ‘one or more processors’. The processes, methods and functional modules be implemented as machine readable instructions executable by one or more processors, hardware logic circuitry of the one or more processors or a combination thereof. Further the teachings herein may be implemented in the form of a software product. The computer software product is stored in a storage medium and comprises a plurality of instructions for making a computer device (which can be a personal computer, a server or a network device such as a router, switch, access point etc.) implement the method recited in the examples of the present disclosure.

The drawings are merely schematic drawings of an example, and the modules or flows in the drawings are not necessary essential for carrying out the disclosure.

The modules in the device in the examples can be distributed in the device in the examples according to the descriptions of the example, or they can be changed so as to be in one or more devices that are different from that in the examples. The modules in the above examples can be either combined into one module or further divided into several sub-modules.

The above sequential numbers mentioned are only for facilitating description, but they are not used to represent which example is more advantage.

The above description includes examples. Any modification, equivalent substitution and improvement made that are according to the spirit and principle of the examples shall be included in the protection scope.

1. A method for establishing dynamic connection, said method comprising:
receiving, by a management server, a connection establishment request message sent by a client, wherein said request message carries a first property information of a service source terminal to which connection is requested to be established;
sending, by the management server, a connection instruction message carrying identification information of the client and said first property information to the service source terminal, so that the service source terminal determines whether to establish a connection to the client according to the first property information.

2. The method according to claim 1, wherein the management server stores a second property information of each service source terminal corresponding to the identification information of each service source terminal; the connection establishment request message further comprises a second property information of the service source terminal to which connection is requested to be established;
said sending, by the management server, a connection instruction message carrying identification information of the client and said first property information to the service source terminal, so that the service source terminal determines whether to establish a connection to the client according to the first property information comprising:
inquiring, by the management server, the corresponding service source terminal according to the second property information carried in the connection establishment request message and the second property information of each service source terminal stored in said management server;
sending, by the management server, said connection instruction message carrying said identification information of the client and said first property information to the inquired service source terminal.

3. The method according to claim 1, wherein the service source terminal determines whether to establish a connection to the client according to the first property information comprising:
determining, by the service source terminal, whether it satisfies said first property information, and if yes, establishing connection to the client and sending service flows to the client; otherwise, not establishing connection to the client.

4. The method according to claim 3, wherein the service source terminal records the connection information between its own and the client and the first property information corresponding to the client;
said method further comprising:
stopping the sending of service flows to the client, when the service source terminal determines, according to the connection information, that it has established connection to the client, and determines that it does not satisfy said first property information corresponding to the client;
establishing connection to the client and sending service flows to the client, when the service source terminal determines, according to the connection information, that it has not established connection to the client, and determines that it satisfies said first property information corresponding to the client.

5. A method for establishing dynamic connection, said method comprising:
receiving, by a service source terminal, a connection instruction message sent by a management server, wherein said connection instruction message carries a first property information of a service source terminal to which the client requests to establish connection;
determining, by the service source terminal, whether to establish connection to the client according to said first property information.

6. The method according to claim 5, wherein determining, by the service source terminal, whether to establish connection to the client according to said first property information comprising:
determining, by the service source terminal, whether it satisfies said first property information, and if yes, establishing connection to the client and sending service flows to the client; otherwise, not establishing connection to the client.

7. The method according to claim 6, wherein the service source terminal records the connection information between its own and the client and the first property information corresponding to the client;
said method further comprising:
stopping the sending of service flows to the client, when the service source terminal determines, according to the connection information, that it has established connection to the client, and determines that it does not satisfy said first property information corresponding to the client;
establishing connection to the client and sending service flows to the client, when the service source terminal determines, according to the connection information, that it has not established connection to the client, and determines that it satisfies said first property information corresponding to the client.

8. A management server, comprising:
a receiving module to receive a connection establishment request message sent by a client, wherein said request message carries a first property information of a service source terminal to which connection is requested to be established;
a sending module to send a connection instruction message carrying identification information of the client and said first property information to the service source terminal, so that the service source terminal determines whether to establish a connection to the client according to said first property information.

9. The management server according to claim 8, wherein the connection establishment request message further comprises a second property information of the service source terminal to which connection is requested to be established;
the management server further comprises:
a storing module to store a second property information of each service source terminal corresponding to the identification information of each service source terminal;
is a determining module to determine the corresponding service source terminal according to the second property information carried in the connection establishment request message received by the receiving module and the second property information of each service source terminal stored in the storing module;
the sending module is to send, to the service source terminal determined by the determining module, a connection instruction message carrying the identification information of the client and said first property information.

10. A service source terminal, comprising:
a receiving module to receive a connection instruction message sent by a management server, wherein said connection instruction message carries a first property information of a service source terminal to which the client requests to establish connection;
a connection establishing module to determine whether to establish connection to the client according to said first property information.

11. The service source terminal according to claim 10, wherein the connection establishing module is to determine whether the service source terminal satisfies said first property information, and if yes, establish connection to the client; otherwise, not establish connection to the client;
the service source terminal further comprises:
a sending module to send service flows to the client when the connection establishing module determines that the service source terminal satisfies said first property information.

12. The service source terminal according to claim 11, wherein further comprising:
a storing module to store the connection information between the service source terminal and the client as well as the first property information corresponding to the client;
the connection establishing module is also to establish connection to the client so as to send service flows to the client by the sending module when it is determined according to the connection information stored in the storing module that the service source terminal does not establish connection to the client and it is determined that the service source terminal satisfies the first property corresponding to the client;
the sending module is also to stop sending service flows to the client when the connection establishing module determines, according to the connection information stored in the storing module, that a connection has been established between the service source terminal and the client, and the connection establishing module determines that the service source terminal does not satisfy the first property information corresponding to the client.
